(19) United States
(12) Patent Application Publication
(10) Pub. No.: US 2017/0129666 A1
(43) Pub. Date: May 11, 2017

(54) LIQUID DISPENSING CAP MECHANISM FOR FLUID CONTAINER, PRE-PACKAGED BEVERAGE AND METHOD

(71) Applicant: VAQUA INC., Chestermere (CA)

(72) Inventor: KYLE SMITH, Chestermere (CA)

(21) Appl. No.: 15/291,881

(22) Filed: Oct. 12, 2016

Related U.S. Application Data
(60) Provisional application No. 62/240,830, filed on Oct. 13, 2015.

(51) Int. Cl. B65D 51/28; B65D 41/04; B65D 47/10; A23L 2/52

(52) U.S. Cl. CPC B65D 51/2835; A23L 2/52; B65D 41/04; B65D 47/10; A23V 2002/00

(57) ABSTRACT

A liquid dispensing cap for a fluid container includes a closure to install the cap on a neck of a fluid container, a liquid storage chamber, a seal applied over an opening to the chamber, a sliding mechanism that moves the seal against a cutter installed in a fixed position adjacent the seal to thereby release a liquid stored in the liquid storage chamber from the cap through the closure and into the fluid container. The cap is used to produce a mixed beverage.

### FIELD OF THE INVENTION

The present invention relates to a liquid dispensing cap mechanism for a fluid container, a pre-packaged beverage and a method.

### BACKGROUND OF THE INVENTION

Various devices have been utilized in the beverage and pharmaceutical arts which permit storing, in isolation in a single pack, of two products and for mixing the products just before use. However, such devices are useful only when it is desired to store a small volume of additional product in a second compartment. Few, if any, devices allow for the storage and mixing of greater than two liquid products due to technical problems including the need for sealing between compartments to permit isolation between the products, and the need for storing relatively considerable volumes of additional product. Mixing of separate products is typically inconvenient and time consuming.

Accordingly, there is thus a need in the art for an improved fluid container or cap for a fluid container for separately storing two liquids for mixing within the fluid container.

### SUMMARY OF THE INVENTION

The present invention relates to a liquid dispensing cap for a fluid container, a prepackaged beverage and a method for operation of the cap.

Broadly stated, in one aspect of the present invention, there is provided a pre-packaged beverage comprising: a fluid container containing a consumable base liquid; a liquid dispensing cap for the fluid container comprising: a closure to install the cap on a neck of the fluid container, and a liquid storage chamber connected to the closure, the liquid storage chamber sealed by a seal and containing a liquid additive; a cutter installed in a fixed position adjacent the seal and configured to break the seal when contacting the seal, to thereby release the liquid additive stored in the liquid storage chamber from the cap through the closure and into the fluid container; a sliding mechanism configured to guide the liquid storage chamber toward the cutter to thereby contact the seal against the cutter; and a releasable lock to releasably lock the liquid storage chamber against moving along the sliding mechanism until the releasable lock is overcome.

In another aspect of the present invention, a liquid dispensing cap for a fluid container is provided, comprising: a closure including a tubular wall with a first open end, a second end, an outer surface extending from the first open end to the second end, a cylindrical inner facing surface extending between the first open end and the second end and defining an inner bore of the closure and a connection mechanism on the cylindrical inner facing surface for releasably securing the closure to a neck of the fluid container; a lid installed over the closure, the lid including an outer surface, an inner tubular wall including an inner bore slidably installed over the closure, a liquid storage chamber within the lid, a spout extending from the liquid storage chamber through the second end into the inner bore, a seal over the spout, the seal configured to contain liquid within the liquid storage chamber but the seal being puncturable to release the liquid through the spout; and a cutter positioned within the closure and adjacent to but spaced from the seal, the cutter including a liquid passage therethrough and a cutting edge protruding towards the seal, wherein the lid is configured to axially slide over the closure by application of force to the outer surface to thereby move the seal against the cutter to open the seal and release the liquid contained therein to pass through the liquid passage.

In yet another aspect of the present invention, a method is provided for producing a beverage for consumption, comprising the steps of: vertically depressing the lid to drive the seal against the cutter and thereby to release the liquid through the spout; shaking the container to mix the liquid dispensed into the contents of the container to form a beverage; and removing the cap to allow consumption of the beverage.

### BRIEF DESCRIPTION OF THE DRAWINGS

FIG. 1A is a schematic illustration of a side exposed view of one embodiment of a container and cap.

FIG. 1B is a schematic bottom plan view of the cap of FIG. 1A. While a seal is shown, chamber walls are shown in phantom behind the seal.

Another embodiment of the invention is further described in the drawing sheets labeled FIGS. 2 and 3, wherein:

FIG. 2 is a vertical section through the neck end of a fluid container with a cap mechanism installed therein; and

FIG. 3 is a top perspective view of the sectional view of FIG. 2.

Another embodiment of the invention is further described in the drawings labeled FIGS. 4 to 7, wherein:

FIG. 4 is a vertical section through the neck end of a fluid container with a cap mechanism installed therein;

FIG. 5 is a bottom perspective view of a cap mechanism similar to that of FIG. 4; and

FIG. 6 is a bottom plan view of the cap mechanism of FIG. 5.

FIGS. 7A to 7E are components of a cap mechanism similar to that of FIG. 4, wherein:

FIG. 7A is a vertical section through a closure and cutter combination,

FIGS. 7B and 7C are a vertical section and a bottom perspective view, respectively, of a liquid chamber portion of a lid;

FIGS. 7D and 7E are a vertical section and a top perspective view, respectively, of a side wall/sliding mechanism of a lid; and

FIGS. 8A and 8B are a bottom perspective view of a liquid chamber portion of a lid and a top perspective view of a closure, respectively.

### DETAILED DESCRIPTION OF VARIOUS EMBODIMENTS

Additional aspects and advantages of the present invention will be apparent in view of the description, which follows. It should be understood, however, that the detailed description and the specific examples, while indicating preferred embodiments of the invention, are given by way of illustration only, since various changes and modifications of the invention will become apparent to those skilled in the art from this detailed description. To the extent that the following description is of a specific embodiment or a particular use of the invention, it is intended to be illustrative only, and not limiting of the claimed invention. The scope of the claims should not be limited by the preferred embodiments set forth in the examples, but should be given the broadest interpretation consistent with the description as a whole.

The invention is described in the accompanying Figures.

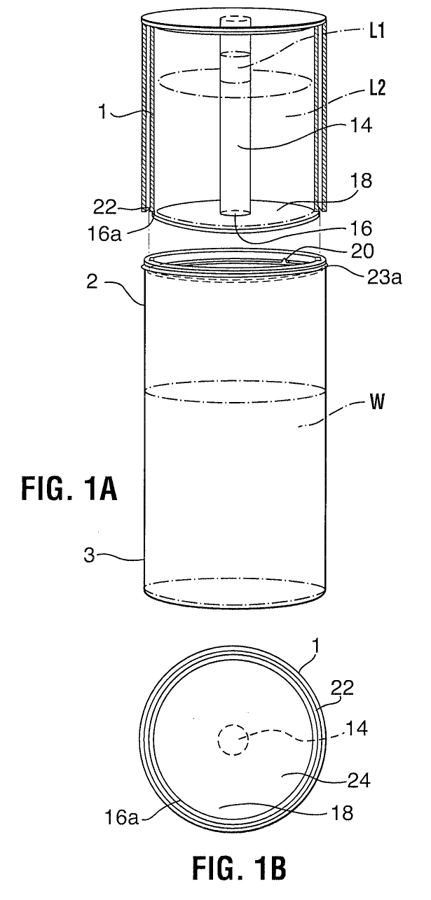

As shown in FIGS. 1A and 1B, the present invention comprises a cap 1 for engagement with the top opening, commonly called a neck 2, of a fluid container 3. As used herein, the term “container” refers to a receptacle configured to store and dispense a liquid. As used herein, the term “liquid” broadly refers to any kind of liquid including, but not limited to, alcoholic or non-alcoholic drinks, syrups, and carbonated or non-carbonated beverages such as, for example, water, beer, pop, mineral water, sports drink, or the like.

In one embodiment, shown in FIGS. 1A and 1B, the cap mechanism includes cap 1 with a liquid storage chamber 14 with an opening 16 sealed by a seal 18. A cutter 20 is installed in a fixed position adjacent the seal. A sliding mechanism 22 on the cap is configured to permit movement of the liquid storage chamber, and thereby the seal, towards and against the cutter to thereby break the seal and release a liquid L1 stored in the liquid storage chamber from the cap into the fluid container.

The sliding mechanism may, for example, be a component of safety threads, interacting parts of which include sliding components of the sliding mechanism and a connection mechanism, such as threads, on the cap and the threads 23a on the neck of the fluid container. Safety threads are configured to permit two actions, a sliding movement as by downward movement of the cap relative to the container and rotation, to unthread the cap from the container. In one embodiment, the seal is broken by the sliding movement to thereby permit the liquids in the cap to be released into the liquid W in the fluid container 3 and the rotation may be employed to remove the cap to permit access to the mixed liquids within the fluid container. If desired, both the sliding movement and the rotation may be employed to break the seal.

As shown, the cap may have more than one liquid storage chamber. The illustrated cap of FIGS. 1A and 1B, for example, is a dual dispensing cap containing chamber 14 and a second chamber 24. The chambers may be concentric relative to one another or otherwise oriented. The chambers may have similar or, as shown, different volumes. Each chamber has an opening, for example, second chamber 24 has an opening 26. Each opening is sealed to contain their liquid contents. In this embodiment, the openings are separate such that fluids therein are maintained separate. In this embodiment, each chamber is arranged to have defining opening edge rims 16, 16a substantially in the same plane such that one seal extends across them to seal both openings.

The cutter may be installed on the container for example, in the neck. The cutter in this embodiment is actually a separate component, independently installed in the container. However, the cutter functions with the cap as part of the overall cap mechanism.

In use of the cap of FIGS. 1A and 1B, when the cap has liquids L1, L2 in its chambers and the cap is installed on the container, the cap may be pushed down and rotated to open the safety threads. This pushing motion moves the cap relative to the cutter. The seal catches on the cutter and the cutter punctures and tears the seal open, thereby releasing the liquid contents from the lid into the container.

The liquid contents L1, L2 may be an alcohol, such as vodka, and/or a flavoring such as juice or sugar water and the container may contain a base liquid W such as water or juice. As such, a mixed drink is produced by actuating the bottle cap to release liquid contents L1, L2 into the base liquid W.

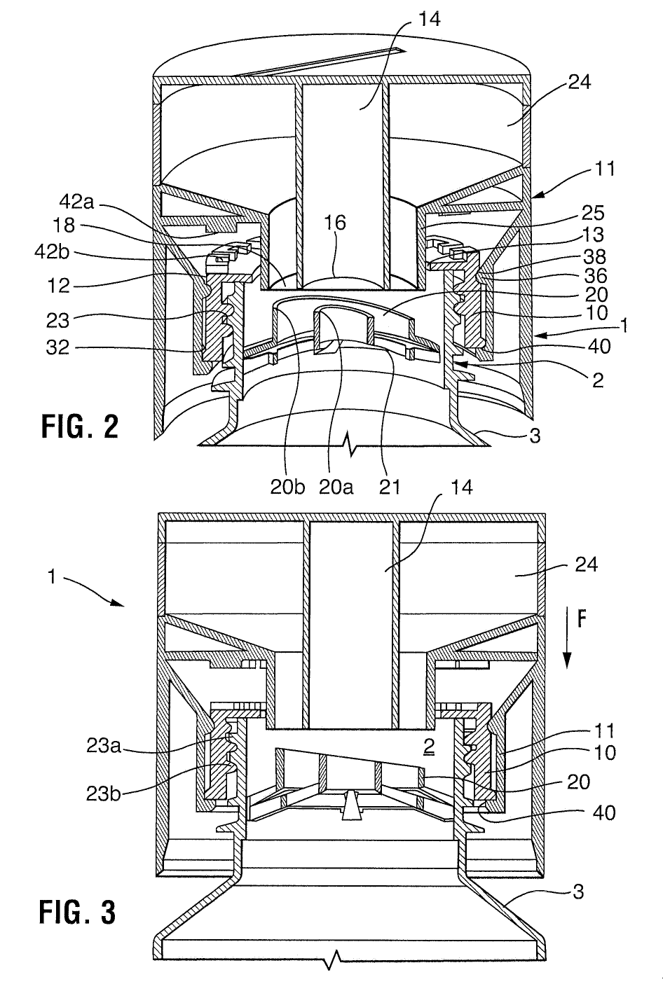

Another embodiment is shown in FIGS. 2 and 3, the cap mechanism includes a closure 10 to install the cap on neck 2 of fluid container 3. The closure includes an end wall 12 and a port 13 extending through the end wall. The closure is connectable to the neck 2 by connection mechanism, such as threads 23b.

The cap mechanism also includes a liquid storage chamber 14 therein with an opening 16 sealed by a seal 18. A second liquid storage chamber 24 is also provided and has an opening adjacent the opening 16. The opening 16 is in communication with the port on the closure. These chambers have their openings in an extension formed as a spout 25 that extends through the port 13 of the closure. The seal extends over the end of the spout.

The cap mechanism also includes a cutter 20 installed in the bottle neck. In this position, the cutter is adjacent the seal.

A sliding mechanism 22 on the cap is configured to permit movement of the liquid storage chamber, and thereby the seal, towards and against the cutter to thereby break the seal and release a liquid stored in the liquid storage chamber from the cap through the port closure and into the fluid container. The cutter has a cutting edge against which the seal is driven when the sliding mechanism is employed to move the cap relative to the cutter. The cutting edges can be shaped to fit into the openings of the chambers on the spout. For example, as shown, the chambers open on the spout with opening 16 being a central hole and the opening of chamber 24 encircling opening 16. Likewise, cutter has two cutting edges: a first center cutting edge 20a and a second cutter edge 20b that is spaced concentrically about the first cutting edge. Cutter 20 includes liquid passage 21 holes there through so that liquid can pass through it, between its top and bottom. The cutter liquid passages may be small enough to prevent the seal from passing through the cutter, such that the seal doesn't drop into the container. The cutter may have a screen type arrangement of cross members between the cutting edges.

In this embodiment, the sliding mechanism is installed between the closure and the cap body portion that carries the liquid chambers. The closure remains in place on the bottle neck as by use of a connection mechanism 23, such as threads 23b, that secures the closure on the threads 23a on the neck. The chambers 14, 24 are carried on a body portion that forms a lid 11 that is positioned telescopically over the closure. The sliding mechanism for example includes a hollow tube 32 sized to fit over the closure. The hollow tube has inwardly extending has ribs 36 that engage into an indentation 38 on the closure's outer side walls. While the ribs are biased into the indention, force applied on the lid can disengage the ribs from indentation 38 and allow the hollow tube to slide further down onto the closure. An end return 40 protrudes radially inwardly on the lower end of the hollow tube 34 prevents the lid from being pulled off the closure.

To permit removal of the cap, there may be engagement gears 42a, 42b on contacting surfaces of each of the lid and the closure. The engagement gears are initially spaced out of engagement, but are moved into contact and interengage, when the lid is slid down over the closure. These gears, when engaged, permit rotation of the lid to be transferred to the closure so that the connection threads can be unthreaded.

Thus, the cap mechanism has two separate chambers for accommodating two liquids such as a flavoring and vodka. Initially, for example prior to actuation of the cap prior to sale or during storage, the cap is in a fixed rest position. The seal is in place and the spout resides in the end of the closure, but is spaced from the cutter. When activated by pushing down anywhere on the lid, the lid slides towards the bottle and the seal is cut by the cutter fixed to the interior of the bottle. This downward action also locks the lid, through gears 42a, 42b, onto the closure and allows the whole assembly to be removed from the bottle.

Before actuation of the cap mechanism, the lid is held on the closure by the rib and the return engaging the closure. The user needs to apply an initial break force, arrow F, to move the lid ribs out of the indentation into which they are biased. This helps seal the bottle and prevents any accidental activation.

The return 40 prevents a user from pulling the lid and the closure apart. Thus, return 40 prevents removal of lid and prevents direct access to the cap-contained liquid. The goal is to prevent the individual liquids from being consumed. The cap mechanism ensures that the liquids in the cap are introduced to the contents of the fluid container before the cap can be removed.

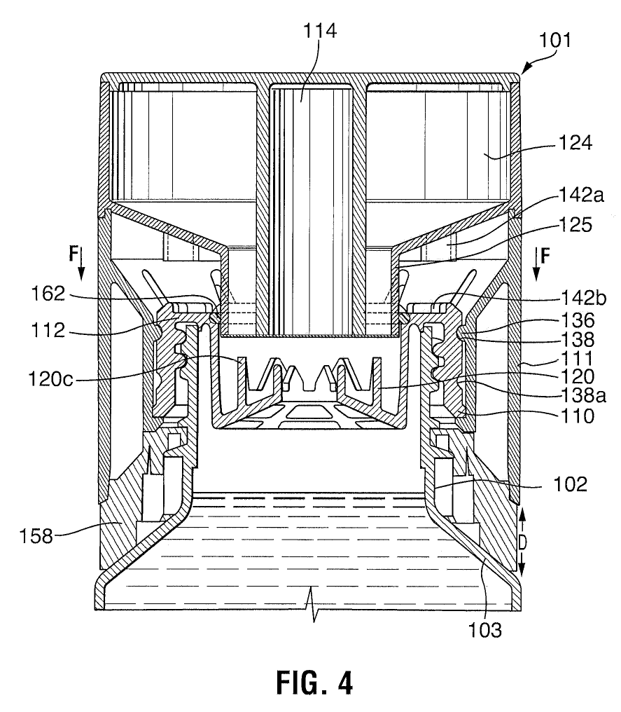

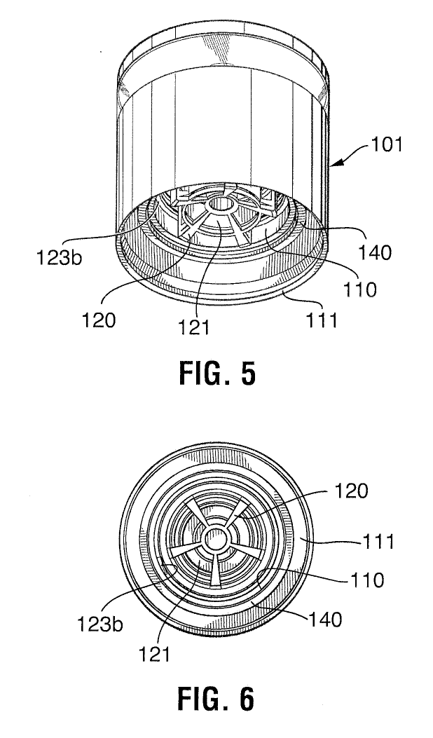

More embodiments of the cap mechanism are shown in FIGS. 4 to 8B. While the cap mechanism 101 of these embodiments is similar to those described above, the figures show a number of optional but beneficial features. For example, the cap mechanism includes a closure 110 with the cutter 120 installed therein, instead of independent installation of the cutter in the bottle neck 102. This improves cost and manufacturing. Also, the cutter includes a number of puncturing teeth 120c. Additionally or alternately, there is a lock mechanism 158 that prevents inadvertent actuation of the lid and may show evidence of product tampering.

As such, the illustrated liquid dispensing cap mechanisms include a closure 110, which includes a tubular wall with a first open end, a second end 112, an outer surface extending from the first open end to the second end and a cylindrical inner facing surface defining extending between the first open end and the second end, which defines an inner bore of the closure. The cap mechanism also includes a cutter 120 positioned within the closure inner bore, the cutter includes a liquid passage therethrough and a cutting edge 120c, herein formed as teeth, protruding upwardly towards the second end.

There is a connection mechanism 123b on the cylindrical inner facing surface for releasably securing the closure to a neck 102 of the fluid container 103.

The cap mechanism further includes a lid 111 installed over the closure, the lid including an outer surface, an inner tubular wall including an inner bore 132 slidably installed over the closure, a first and second liquid storage chambers 114, 124 within the lid, a spout 125 with the liquid storage chambers therein terminating at openings 116 to the chambers, the spout extends into the inner tubular wall. There is a seal 118 positionable over the spout, the seal is configured to contain liquid within the liquid storage chambers but the seal is puncturable to release the liquid through the spout, when punctured.

The lid and the closure are assembled such that closure 110 is positioned within the inner bore and the spout 125 extends through a port 113 in the second end of the closure and, thereby, into the closure's inner bore. In this position, the end of the spout, and thereby the seal, is positioned adjacent the cutter's cutting edge; and the lid is configured to axially slide over the closure by application of force to the outer surface of the lid to thereby move the seal against the cutter to open the seal and release the liquid contained therein to pass through the liquid passage.

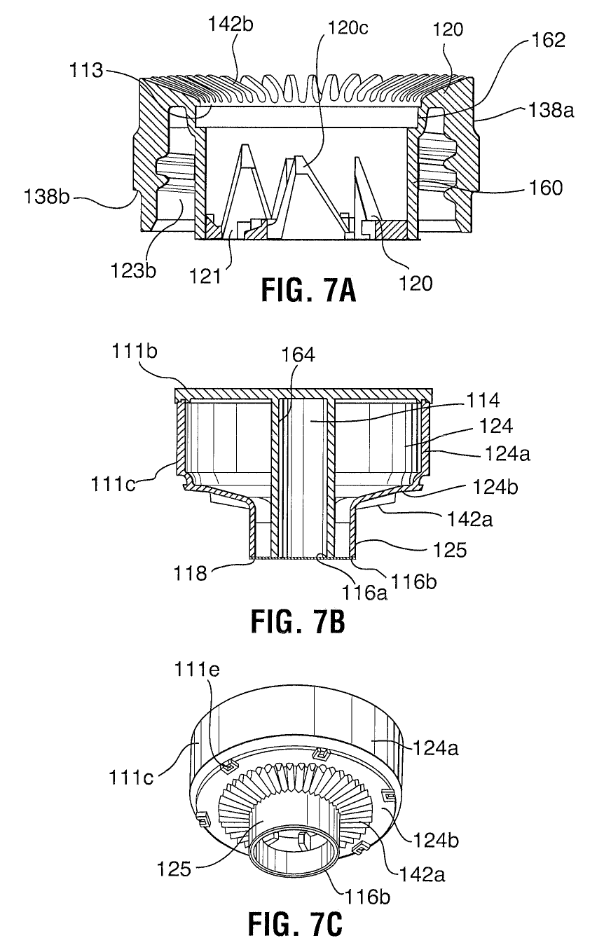

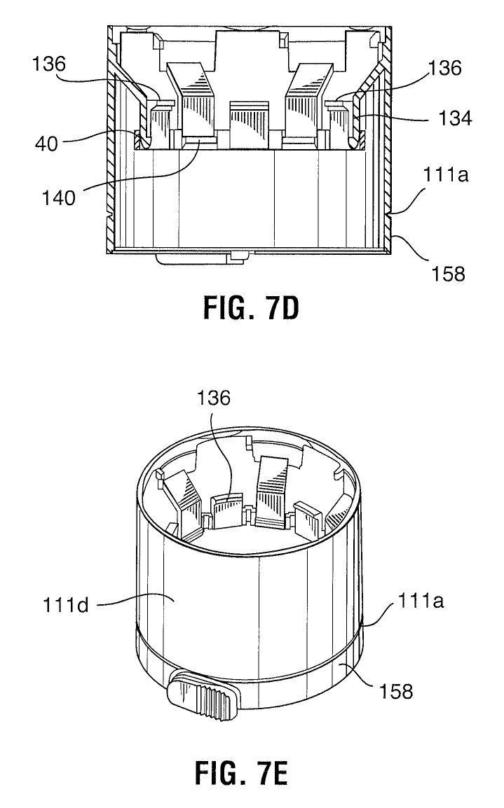

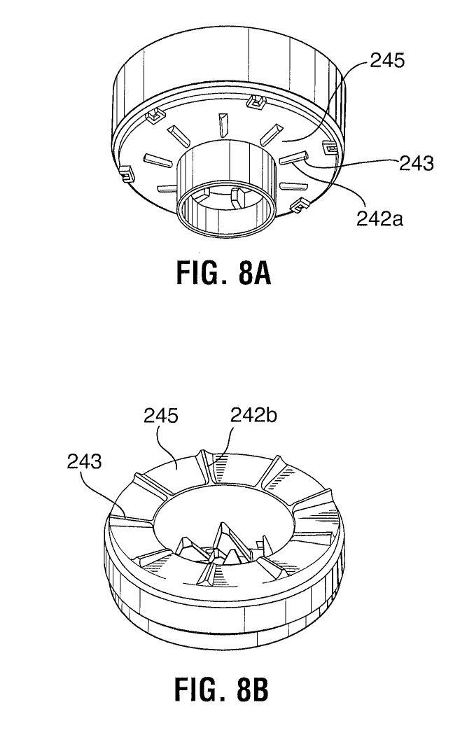

In some embodiments, the cap may have one or more of the following:
the configuration to permit axial sliding of the lid over the closure may operate by with the lid 111 inner bore 132 positioned to ride telescopically over the closure, while the spout moves telescopically through port 113. There may be a sliding mechanism with inwardly extending ribs 136 that engage into a first indentation 138a on the closure's outer side walls but are moveable to a second indentation 138b. While the ribs are biased into the indentions, they may flex to move out of the indentations. For example, the ribs may be formed on collet fingers that permit them to radially expand when a force applied is applied along arrow F against the lid. Ribs 136 can disengage from indentation 138a and allow the hollow tube to slide further down onto the closure until they land in indentation 138b. An end return 140 may protrude radially inwardly on the lower end of the hollow tube 34 that prevents the lid from being pulled off the closure;
there may be a removable lock 158 to prevent sliding movement of the lid relative to the closure until the removable lock is removed. In particular, in one embodiment, sliding movement of the lid relative to the closure is made through a distance D and the cap mechanism is configured such that when it is initially placed on a container, with closure 110 threaded onto neck 103 and lid 111 not yet slid down, space D is provided between the bottom edge 111a of the lid and the bottle. The lock 158 may, for example, be a removable spacer that such as a tab and/or tear off strip that prevents the lid from moving toward the bottle until it is removed;
the cutter may be secured to an inner cylindrical wall 160 that extends down from the port 113 of the closure;
the cutting edge, for example each tooth 120c, has a leading point and a trailing edge and the leading point cuts the seal first followed by the trailing edge;
the cutter may include a screen and the liquid passage 121 is defined by openings between cross members forming the screen. The screen prevents the seal or parts thereof from passing down through the cutter;
there may be a seal, such as an o-ring 162, between the spout 125 and the port 113. The o-ring may be installed in a gland 162a in the closure port 113 or on the cylindrical wall 160. O-ring 162 maintains a seal against leakage between spout 125 and port 113, while also permitting movement of the spout up and down through the port;
the connection mechanism 123b may be threads that connect to threads on the container and there may further be a set of engagement gears 142a, 142b, with some engagement gears 142a on the lid and some engagement gears 142b on the closure that are configured to substantially rotationally lock rotational movement of the lid relative to the closure. The engagement gears are on surfaces of the lid and the closure that only contact after the lid is slid down over the closure, thus requiring the lid to be depressed to engage against the closure and interlock the gears 142a with gears 142b before the closure can be rotated to unthread from the container;
gears 142a, 142b substantially rotationally lock rotational movement of the lid relative to the closure, such that when the gears are brought together, rotation of the lid causes rotation of the gears 142a thereon and these gears engage gears 142b on the closure to transfer rotational energy to the closure. This rotation causes the closure to be rotated off the neck of the container. However, when the gears are not brought together, rotation of the lid does not in any way cause rotation of the closure;
gears 142a, 142b can take many forms. For example, the gears in FIG. 4 have square-shaped protruding and recessed surfaces, while the gears in FIG. 7A/7C have protruding and recessed engaging surfaces that are more V-shaped;
in one embodiment, shown in FIGS. 8A and 8B, gears 242a, 242b are shown that have raised teeth 243 with spaces 245 between the teeth. The teeth are configured to become engaged to ensure rotation of the lid to cause rotation of the closure. However, the spaces between the teeth permit the lid to be rotated to some degree back and forth, as determined by the size of the space, even when the lid is moved down to bear against the the closure. This ability to rotate the lid back and forth permits the cutting teeth 120c to be rotated to tear open the seal after the teeth 120c puncture the seal. This ensures that the holes through the seal are not plugged by the teeth and the liquid can more readily drain from the chambers 124 into the container;
the threads 123a, 123b may be configured for reconnection such that once the cap is removed from the bottle, the threads are reconnectable to permit recapping of the container if desired;
one of the liquid storage chambers may be defined by a side wall 124a and a bottom wall 124b, the bottom wall may be shaped frustoconically and may slope from the side wall toward the spout such that the slope urges liquid in the liquid storage chamber to flow towards the spout;
the side wall 124a may form a portion of the outer surface of the lid and may be translucent to show the contents of the storage chamber, which may be attractive if the contents are coloured;
the liquid storage chambers may have openings that are defined by rim edges 116a, 116b at the open end of the spout. These rim edges may be in plane with each other such that seal 118 may be a single planar member sealed to both the rim edges;
in one embodiment, the two liquid storage chambers are positioned substantially concentrically, with one centrally located such as in the form a cylindrical chamber defined within a cylindrical wall 164 and with the second liquid storage chamber encircling the centrally located chamber. The central liquid storage chamber may include a dispensing end terminated at rim edge 116a and the dispensing end extends substantially concentrically within the spout. In such an embodiment, the seal 118 may seal against both the spout and the dispensing end. The cutting edge 120 may include puncturing teeth 120c aligned both with an annular space between the spout and the dispensing end and with an open space radially within rim 116a of the dispensing end;
there may be centering fins 165 within the spout that centralize the cylindrical wall 154; and/or
an assembly of parts such as shown in FIGS. 7B to 7E may be employed to form lid 111. For example, FIG. 7B shows an assembly of two parts 111b, 111c that form the upper portion of the lid which has outer surfaces and houses the chambers 114, 124. FIG. 7C shows just part 111c, without part 111b installed. FIGS. 7D and 7E show a possible lower portion 111d of the lid, including the sliding mechanism ribs 136 and return 140. Part 111c may connect to part 111d via an annular connection 111e that may include anti-rotation connections 111f.

In another aspect of the present invention, a container comprising one of the above caps is provided.

In use, the cap 101 and container 103 are manipulated to dispense a beverage by: vertically depressing the lid to drive the seal against the cutter and thereby to release the liquid from chambers 114, 124 through the spout; and removing the cap to allow consumption of the beverage.

The method may after depressing the lid, include shaking the container to mix the liquid dispensed into the contents of the container to form a beverage.

In one embodiment, the method further comprises replacing the cap after consumption.

The cap and the method of the present invention, may provide one or more of the following:
(1) The cap accommodates the storage of a single liquid or the storage of two different liquids separately for subsequent mixing with another different liquid in a beverage container.
(2) The cap dispenses two different fluids into a single beverage container by means a dispensing mechanism that is user-activated and controlled.
(3) The mechanism includes a chamber within the cap in which liquid may be sealed by application of a seal across an opening to the chamber and cutter that is configured to open, as by puncturing or otherwise cutting, the seal on the cap to release liquid from the cap preferably without the seal or portion thereof falling into the container. The mechanism may be configured such that the cutter is brought into contact with the seal, to cut the seal by depressing the cap. When the cap is depressed by the user, the dispensing mechanism dispenses the entire volume of the fluid into the beverage container.
(4) The fluid within the beverage container remains separate from the fluids in the dispensing portion and canister until activated by the user.
(5) Since the different liquids are stored separately, the quality and flavor of each liquid are preserved prior to each mixing with the beverage in the container.
(6) Each of the dispensing mechanism and the beverage container are manufactured in such a manner that the liquids in the cap and the liquid in the beverage container are each sealed against contamination or leakage before use.
(7) In an exemplary embodiment, the liquids contained in the cap are vodka and possibly a flavoring and the liquid within the beverage container is water. Actuation of the cap dispenses the vodka and the flavoring into the water to create a fresh-mixed drink.

It should be apparent to those skilled in the art that many more modifications besides those already described are possible without departing from the inventive concepts herein. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A liquid dispensing cap for a fluid container, comprising:
a closure including a tubular wall with a first open end, a second end, an outer surface extending from the first open end to the second end, a cylindrical inner facing surface extending between the first open end and the second end and defining an inner bore of the closure and a connection mechanism on the cylindrical inner facing surface for releasably securing the closure to a neck of the fluid container;
a lid installed over the closure, the lid including an outer surface, an inner tubular wall including an inner bore slidably installed over the closure, a liquid storage chamber within the lid, a spout extending from the liquid storage chamber through the second end into the inner bore, a seal over the spout, the seal configured to contain liquid within the liquid storage chamber but the seal being puncturable to release the liquid through the spout; and
a cutter positioned within the closure and adjacent to but spaced from the seal, the cutter including a liquid passage therethrough and a cutting edge protruding towards the seal,
wherein the lid is configured to axially slide over the closure by application of force to the outer surface to thereby move the seal against the cutter to open the seal and release the liquid contained therein to pass through the liquid passage.

2. The liquid dispensing cap of claim 1, wherein the liquid storage chamber includes a transparent wall exposed on an outer surface of the lid, such that any liquid within the liquid storage chamber can be seen through the transparent wall.

3. The liquid dispensing cap of claim 1, wherein the lid rides telescopically over the closure.

4. The liquid dispensing cap of claim 1, wherein the cutter is secured in the neck of the fluid container.

5. The liquid dispensing cap of claim 1, wherein the cutter is secured to the closure.

6. The liquid dispensing cap of claim 1, wherein the connection mechanism is threads.

7. The liquid dispensing cap of claim 6, wherein the threads are safety threads requiring the lid to be depressed to engage against the closure before the closure can be rotated to unthread.

8. The liquid dispensing cap of claim 6, wherein the safety threads include a first gear on the closure and a second gear on the lid that are formed to engage when the lid is depressed onto the closure, and the first and second gears allow some rotational movement of the lid relative to the closure while the first and second gears are engaged.

9. The liquid dispensing cap of claim 1, further comprising a removable lock to prevent sliding movement of the lid relative to the closure until the removable lock is removed.

10. The liquid dispensing cap of claim 9, wherein the removable lock is a removable tab.

11. The liquid dispensing cap of claim 9, wherein the removable tab is positioned at a lower edge of the lid and is configured to stop sliding movement of the lid towards the fluid container.

12. The liquid dispensing cap of claim 1, wherein the liquid storage chamber includes a side wall and a bottom wall, the bottom wall is shaped frustoconically and slopes from the side wall toward the spout such that liquid in the liquid storage chamber flows toward the spout.

13. The liquid dispensing cap of claim 1, further comprising a second liquid storage chamber in the lid.

14. The liquid dispensing cap of claim 1, wherein the seal seals both the liquid storage chamber and the second liquid storage chamber.

15. The liquid dispensing cap of claim 1, wherein the second liquid storage chamber is positioned substantially concentrically within the liquid storage chamber and includes a dispensing end extending substantially concentrically within the spout.

16. The liquid dispensing cap of claim 15, wherein the seal seals both the spout and the dispensing end.

17. The liquid dispensing cap of claim 15, wherein the cutting edge is aligned with an annular space between the spout and the dispensing end and further comprising a second cutting edge aligned with an open space at the dispensing end.

18. The liquid dispensing cap of claim 1, wherein the cutting edge is circular and the second cutting edge is circular and is positioned substantially concentrically within the cutting edge.

19. The liquid dispensing cap of claim 1, wherein the liquid storage chamber includes a cylindrical side wall and a frustoconical bottom wall sloping from the cylindrical side wall to the spout and the second liquid storage chamber is shaped as a tube with a dispensing end, the tube extending substantially concentrically within the cylindrical side wall, the frustoconical bottom wall and the spout.

20. The liquid dispensing cap of claim 1, wherein the cutter is configured to open both the liquid storage chamber and the second liquid storage chamber.

21. The liquid dispensing cap of claim 1, wherein the cutting edge has a leading point and a trailing edge and the leading point cuts the seal first followed by the trailing edge.

22. The liquid dispensing cap of claim 1, wherein the cutter includes a screen and the liquid passage is defined by openings through the screen, to thereby prevent the seal from passing through the cutter.

23. A pre-packaged beverage comprising:
a fluid container containing a consumable base liquid;
a liquid dispensing cap for the fluid container comprising:
a closure to install the cap on a neck of the fluid container,
a liquid storage chamber connected to the closure, the liquid storage chamber sealed by a seal and containing a liquid additive;
a cutter installed in a fixed position adjacent the seal and configured to break the seal when contacting the seal, to thereby release the liquid additive stored in the liquid storage chamber from the cap through the closure and into the fluid container;
a sliding mechanism configured to guide the liquid storage chamber toward the cutter to thereby contact the seal against the cutter; and
a releasable lock to releasably lock the liquid storage chamber against moving along the sliding mechanism until the releasable lock is overcome.

24. A method of using the container of claim 23 to mix a beverage in the fluid container for consumption, the method comprising the steps of:
depressing the lid toward the fluid container to drive the seal against the cutter and thereby to release the liquid additive from the liquid storage chamber through the seal and into the fluid container; and
removing the cap to allow consumption of the beverage.

25. The method of claim 24, further comprising replacing the cap after consumption.
